(19) United States
(12) Patent Application Publication
(10) Pub. No.: US 2010/0137121 A1
(43) Pub. Date: Jun. 3, 2010

(54) GLASS ARTICLE WITH IMPROVED CHEMICAL RESISTANCE

(75) Inventors: Fabian Mariage, Jumet (BE); Pierre Boulanger, Jumet (BE); Dominique Coster, Jumet (BE); Francois Lecolley, Jumet (BE); Marc Van Den Neste, Jumet (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC FLAT GLASS EUROPE S.A., Bruxelles(Watermael-Boitsfort) (BE)

(21) Appl. No.: 12/597,647

(22) PCT Filed: Apr. 25, 2008
(86) PCT No.: PCT/EP08/55086

§ 371 Date: Oct. 26, 2009

(30) Foreign Application Priority Data
Apr. 26, 2007 (EP) 07107026.2

(51) Int. Cl. C03C 14/00

(52) U.S. Cl. 501/32; 977/773

(57) ABSTRACT

Glass article with improved chemical resistance comprising a chemical reinforcing agent in the form of inclusions of nanoparticles, especially partially crystalline nanoparticles, in the bulk of the glass near one surface of the article.

The present invention relates to a glass article having an increased and improved chemical resistance compared to known glass articles.

It is known that unless it has undergone protective treatment, glass can corrode under the effects of adverse environmental conditions, in particular in aqueous environments with an alkaline pH. If the glass is soda-lime glass, the cations of alkaline metals such as Na⁺ and to a lesser extent K⁺ can discharge from to the glass if close to its surface, and dissolve in the surrounding environment, e.g. in the presence of humidity or trickling water. Various methods have been proposed to restrict this phenomenon such as, for example, a treatment for depleting these ions in the vicinity of the surface of the glass article. This method consists of treating the surface of the glass with a chemical agent that is able to eliminate or greatly reduce the sodium and/or potassium content in a thin zone close to this surface.

However, the efficacy of this technique is limited in time as a result of the phenomenon of the slow diffusion of the Na⁺ and K⁺ ions coming from the core of the glass article caused by the concentration gradient created by the treatment for the depletion of these ions in the vicinity of the surface.

The invention remedies these disadvantages by providing a glass with improved chemical resistance, which is stable in various environmental conditions, possibly in alkaline aqueous environments, no longer requires any special treatment for the depletion of Na⁺ and/or K⁺ ions and is resistant for extended periods of use.

On this basis, the invention relates to a glass article such as that defined in claim 1.

The dependent claims define other possible practical examples of the invention, of which some are preferred.

The glass article according to the invention is formed from an inorganic type of glass that can belong to various categories. Thus, the inorganic glass can be a soda-lime glass, a borate glass, a lead glass, a glass containing one or more additives homogeneously distributed throughout its bulk such as e.g. at least one inorganic colouring agent, an oxidising compound, an agent for regulating viscosity and/or a melting promoter. The inorganic glass can also have undergone a thermal toughening process for the purpose of improving its surface hardness. The glass article according to the invention is preferably formed from a clear or bulk coloured soda-lime glass. The expression “soda-lime glass” is used here in its broad sense and relates to any glass that contains the following basic components (expressed in percentages by total weight of glass):

| | |
|---|---|
| SiO₂ | 60 to 75% |
| Na₂O | 10 to 20% |
| CaO | 0 to 16% |
| K₂O | 0 to 10% |
| MgO | 0 to 10% |
| Al₂O₃ | 0 to 5% |
| BaO | 0 to 2% |
| BaO + CaO + MgO | 10 to 20% |
| K₂O + Na₂O | 10 to 20%. |

It also relates to any glass containing the above basic components that can additionally contain one or more additives.

In general, it is also preferred that the glass article has not been covered by any layer before receiving the treatment of the present invention, at least on the surface where chemical resistance is to be improved.

The glass article according to the invention has an improved chemical resistance. This is understood to mean an improved resistance to chemical agents compared to that of known glasses. Chemical agents are understood to be atmospheric agents such as rainwater possibly containing pollutants usually encountered in the atmosphere, in dissolved or suspended state, as well as certain synthetic solutions, in particular aqueous solutions, containing alkalisation, acidification and/or oxido-reduction chemical agents possibly in the presence of various organic or inorganic solvents. The resistance of the article according to the invention is indicated by an absence of corrosion or loss of weight under the extended influence of chemical agents for periods that can extend over several years, or at least a significant reduction in this corrosion or loss of weight down to insignificant values for usage of the article.

According to the invention, the glass article contains at least one chemical reinforcing agent. This chemical reinforcing agent is a chemical composition that can include components that are totally foreign to the composition of the bulk of the glass of the article. Conversely, in a variant, it can also contain one or more chemical compounds that are already present in the composition of the bulk of the glass of the article.

According to the invention, the chemical reinforcing agent is formed by inclusions of nanoparticles that are found below the surface of the glass of the article at a close distance from this. The inclusions according to the invention can be formed from an assembly of a plurality of nanoparticles or, conversely, can each constitute an isolated nanoparticle.

According to the invention, the dimensions of the nanoparticles are not smaller than 2 nm and preferably not smaller than 10 nm. Moreover, the dimensions of the nanoparticles are not larger than 500 nm and preferably not larger than 100 nm.

Each nanoparticle is formed from a single chemical compound of a chemical reinforcing agent. In a variant, it can also be formed from a composition of a plurality of different chemical reinforcing agents. In this latter case, the composition is not necessarily homogeneous.

According to a preferred feature of the article according to the invention, the inclusions are formed from at least one inorganic compound. According to this feature, each nanoparticle is formed by at least one inorganic chemical compound of a chemical reinforcing agent. Any inorganic chemical compound that eliminates or reduces corrosion or loss of weight of the glass article is suitable.

However, it is generally preferred that the inorganic chemical compound forming the nanoparticles in the glass article according to the invention is selected from the oxides, nitrides, carbides and associations of at least two oxides and/or nitrides and/or carbides.

It is even further preferred if the inorganic compound is selected from the oxides of magnesium, calcium, strontium, barium or from the oxides, nitrides and carbides of scandium, yttrium, lanthanum, titanium, zirconium, vanadium, niobium, tantalum, aluminium, gallium, indium, silicon, germanium, tin, and associations of at least two of the above compounds.

Of these compounds, aluminium oxide and silicon oxide have provided excellent results. Aluminium(III) oxide (Al₂O₃), when used alone, has been found to be a chemical reinforcing agent of great interest. Equally, silicon(IV) oxide (SiO₂) used on its own has also provided a glass effectively reinforced by nanoparticles.

According to another preferred feature of the invention, the inclusions of nanoparticles are at least partially crystallised, i.e. crystals constitute a proportion of at least 5% of their weight. The crystals can belong to several different crystallisation systems. In a variant, they can also all be from the same crystallisation system. At least 50% by weight of the inclusions are preferably in crystallised form. It is particularly preferred if all the inclusions are in crystallised form. By way of example, where aluminium(III) oxide is used as chemical reinforcing agent, the results have shown in particular that inclusions of predominantly crystallised nanoparticles and crystals belonging to two different crystallisation systems—tetragonal (δ-Al₂O₃)₈ and cubic (η-Al₂O₃)—were obtained.

According to a particular feature of the article of the invention, the inclusions are quasi-spherical in shape. Quasi-spherical is understood to mean a three-dimensional shape, the volume of which relates to that of a sphere having a diameter that would be equal to the largest dimension of an object having this quasi-spherical shape. It is preferred that the inclusions have a volume equal to at least 80% of that of the sphere having a diameter equal to the largest dimension of the inclusions.

According to another particular feature of the article of the invention, the size of the inclusions is not smaller than 5 nm and preferably not smaller than 50 nm. Moreover, the size of the inclusions is not larger than 500 nm and preferably not larger than 350 nm. Size is understood to mean the largest dimension of the inclusions.

According to a first special embodiment of the invention, the concentration of inorganic compound is distributed into the depth of the glass in accordance with a profile that has a maximum peak at a distance from the surface of not less than 5 nm, preferably not less than 30 nm. Moreover, said maximum peak is at a distance from the surface of not more than 250 nm, most frequently not more than 200 nm and preferably not more than 90 nm.

According to this first embodiment, the concentration profile of inorganic compound most frequently shows a continuous monotonic decrease, starting from a concentration corresponding to that of the peak and in the direction of the core of the article, that tends towards zero or towards a constant value identical to the concentration possibly present in the core from a depth of not less than 300 nm and preferably not less than 600 nm. Moreover, said depth is at a distance from the surface of not more than 2500 nm and preferably not more than 2000 nm.

According to a second special embodiment of the invention, the concentration of inorganic compound can also be distributed in the depth of the glass according to a profile that decreases continuously in a monotonic manner starting from the surface of the glass and tends towards zero or a constant value identical to the concentration possibly present in the core from a depth of not less than 300 nm and preferably not less than 400 nm. Moreover, said depth is at a distance from the surface of not more than 2500 nm and preferably not more than 2000 nm.

According to another embodiment of the article of the invention that is compatible with all the particular embodiments and features described above, the glass of the article is formed from a flat soda-lime type glass sheet.

The article according to the invention can be obtained using any process suitable for generating or incorporating nanoparticles into the bulk of the glass close to a surface of said article in the form of inclusions.

In particular, the invention relates to an article consistent with the above descriptions that is obtained by a process comprising (a) the production of nanoparticles, (b) the deposition of nanoparticles onto the surface of said article, and (c) the supply of energy to the nanoparticles and/or to said surface in such a manner that the nanoparticles diffuse/dissolve into the glass. Such a method is disclosed in patent application WO 2007/110482 A2.

The formation and deposition of nanoparticles on the surface of the glass article can be achieved simultaneously in one step using known methods such as
chemical vacuum deposition (or CVD): a chemical deposition process in modified vapour phase (or MCVD) can be used in the present invention. This modified method differs from the classic procedure in that the precursor reacts in gaseous phase rather than on the surface of the glass.
deposition by humid procedure such as sol-gel deposition, or
flame spraying starting with a liquid, gaseous or solid precursor.

In the flame spraying method quoted by way of example and disclosed in particular in patent application FI20050595A, the nanoparticles are generated by atomising a solution of at least one chemical precursor in an aerosol transported in a flame where combustion occurs to form solid nanoparticles. These nanoparticles can then be deposited directly onto the surface positioned close to the edge of the flame. This method has given good results in particular.

In a variant, the formation and deposition of nanoparticles on the surface of the glass article can be achieved consecutively in two steps. In this case, the nanoparticles are firstly generated in solid form or in the form of a suspension in a liquid by vapour, by humidity (sol-gel, precipitation, hydrothermal synthesis . . . ) or by dry process (mechanical crushing, mechano-chemical synthesis . . . ). An example of a method that allows nanoparticles to be firstly generated in solid form is a method known as combustion chemical vapour condensation (or CCVC). This method consists of converting in a flame a precursor solution in vapour phase that undergoes a combustion reaction to provide nanoparticles that are ultimately collected.

The initially generated nanoparticles can then be transferred to the surface of the glass article by different known methods.

The energy necessary for diffusing/dissolving the nanoparticles in the glass can be supplied by heating the glass article to an appropriate temperature.

According to the invention, the energy necessary for diffusion of the nanoparticles in the glass can be supplied at the instant the nanoparticles are deposited or subsequently after deposition.

The following example illustrates the invention without intending to restrict its coverage in any way.

### EXAMPLE 1

### According to the Invention

A 4 mm thick clear soda-lime float glass sheet 20 cm×20 cm in dimension was washed in flowing water, deionised water and isopropylene alcohol in succession and then dried.

Hydrogen and oxygen were introduced into a spot-type burner in order to generate a flame at the outlet of said burner. One of the previously washed surfaces of the glass sheet was placed close to the edge of the flame. A solution containing non-anhydrous aluminium nitrate, Al(NO₃)₃.9H₂O, dissolved in methanol (dilution ratio by weight aluminium/methanol=1/80) was introduced into the flame. Nanoparticles of aluminium oxide were thus generated in this flame and then collected on the surface of the glass sheet, which was firstly heated in an oven to a temperature of 650° C. In order to cover the whole surface of the glass sheet, the burner is movable in two directions in the area within the plane of said sheet. The head of the burner is continuously displaced in one of the two directions at a speed fixed at 3 metres per minute and in the other direction, which is perpendicular to the first direction, with jumps of 2 centimetres.

When the nanoparticles have been deposited, the glass sheet is cooled in a controlled manner at a maximum rate of 35° C. per hour.

The glass sheet treated as described above was analysed using transmission and scanning electron microscopy, atomic force microscopy, X-ray fluorescence spectrometry, X-ray photoelectron spectroscopy and secondary ion mass spectrometry. The conducted analyses showed that the aluminium was incorporated into the bulk of the glass close to the surface in the form of aluminium oxide, Al₂O₃. The nanoparticle inclusions vary in size from 10 to 100 nm. The nanoparticles are predominantly crystalline and the crystals belong to two different crystallisation systems: tetragonal (δ-Al₂O₃) and cubic (η-Al₂O₃).

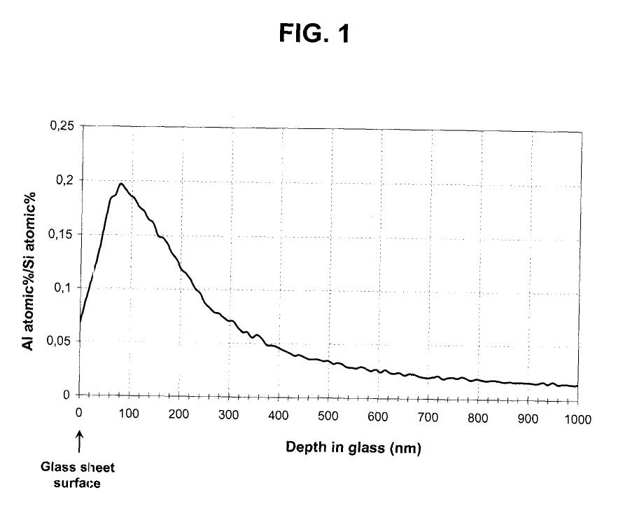

FIG. 1 shows the atomic ratio of Al/Si as a function of the depth in the glass sheet from the treated surface. It illustrates the incorporation of the aluminium into the bulk of the glass sheet close to a surface of the sheet. The concentration of aluminium is distributed in the depth of the glass according to a profile that shows a maximum peak at a distance of go nm from the surface.

Climate chamber analyses allowing accelerated ageing of the treated glass sheet were conducted to show the effect of the incorporation of aluminium oxide nanoparticles on the chemical resistance of the glass. A comparison was performed with an identical, but untreated (reference) glass sheet.

In the climate chamber the treated glass sheet and the reference glass sheet were exposed to temperature cycles of between 45° C. and 55° C. at a constant relative humidity of 98% for up to 20 days. The period of one cycle is exactly 1 hour and 50 minutes and 12 cycles occur in one day. Once a day the temperature decreases from 45° C. to 25° C. in 30 minutes and is maintained at 25° C. for one hour. The temperature then increases again from 25° C. to 45° C. in 30 minutes and a temperature cycle starts again. The glass sheets are examined after precise time periods.

After 4 days in the climate chamber, the untreated reference glass sheet exhibits signs of corrosion. In contrast, the glass sheet treated using the method described above still shows no sign of corrosion after 20 days in the climate chamber. The presence of aluminium oxide nanoparticles in the bulk of the glass close to one of its surfaces thus allows a glass with improved chemical resistance to be obtained.

### EXAMPLE 2

### According to the Invention

A 4 mm thick clear soda-lime float glass sheet 20 cm×20 cm in dimension was washed in flowing water, deionised water and isopropylene alcohol in succession and then dried.

A dry powder of aluminium oxide nanoparticles such as that supplied by PlasmaChem was deposited by dusting onto the surface of the previously washed glass sheet. The nanoparticles used varied in size from 5 to 150 nm. They are predominantly crystalline and the crystals belong to three different crystallisation systems: rhombohedral (α-Al₂O₃), tetragonal (δ-Al₂O₃) and cubic (η-Al₂O₃).

When the nanoparticles have been deposited, the glass sheet is heated in an oven to a temperature of 900° C. for 1 hour and then cooled in a controlled manner at a maximum rate of 35° C. per hour.

The glass sheet treated as described above was analysed using the same techniques are specified in Example 1. The analyses showed that the aluminium oxide nanoparticles were incorporated into the bulk of the glass close to the surface and the results obtained with respect to size and crystallinity are consistent with the initial characteristics of the nanoparticles used. Moreover, the concentration of aluminium is distributed in the depth of the glass according to a profile that shows a continuous monotonic decrease towards a constant value identical to the concentration of aluminium present in the core from a depth equal to 700 nm.

1. A glass article comprising at least one chemical reinforcing agent in a section of the glass article close to a surface of the glass article, wherein the chemical reinforcing agent is formed from at least one nanoparticle inclusion.

2. The article according to claim 1, wherein the at least one nanoparticle inclusion is at least partially crystallised.

3. The article according to claim 1, wherein the at least one nanoparticle inclusion is fully crystallised.

4. The article according to claim 1, wherein the at least one nanoparticle inclusion is formed from at least one inorganic compound.

5. The article according to claim 1, wherein the inorganic compound is at least one selected from the group consisting of an oxide, a nitride, and a carbide.

6. The article according to claim 4, wherein the inorganic compound is at least one oxide selected from the group consisting of magnesium, calcium, strontium, barium, yttrium, titanium, zirconium, vanadium, niobium, tantalum, aluminium, gallium, indium, silicon, germanium, tin, and lanthanum.

7. The article according to claim 4, wherein the inorganic compound is an aluminium(III) oxide.

8. The article according to claim 6, wherein the inorganic compound is a silicon(IV) oxide.

9. The article according to claim 1, wherein the at least one nanoparticle inclusion is quasi-spherical in shape.

10. The article according to claim 1, wherein the size of the at least one nanoparticle inclusion ranges between 5 and 500 nm.

11. The article according to claim 4, wherein a concentration of the inorganic compound is distributed in the depth of the glass according to a concentration profile showing a maximum peak at a distance from the surface in the range of between 5 and 250 nm.

12. The article according to claim 11, wherein the maximum peak of the concentration profile of the inorganic compound is located at a distance of between 30 and 200 nm from the surface.

13. The article according to claim 11, wherein the concentration profile of the inorganic compound shows a continuous monotonic decrease, starting from a concentration corresponding to that of the peak in the direction of the core of the article, that tends towards zero or towards a constant value identical to the concentration possibly present in the core from a depth at a distance from the surface in the range of between 300 nm and 2500 nm.

14. The article according to claim 4, wherein the concentration of the inorganic compound is distributed in the depth of the glass according to a profile that decreases in a monotonic manner from the surface of the glass and tends towards zero or towards a constant value identical to the concentration possibly present in the core of the article from a depth at a distance from the surface in the range of between 300 nm and 2500 nm.

15. The article according to claim 1, wherein the nanoparticle of the at least one nanoparticle inclusion is generated in a flame starting from at least one precursor.

16. The article according to claim 1, wherein the glass of the glass article is formed from a flat soda-lime glass sheet.

17. The article according to claim 9, wherein quasi-spherical is a three-dimensional shape having a volume equal to at least 80% of a sphere, said sphere having a diameter equal to the largest dimension of the at least one nanoparticle inclusion.
